(19) United States
(12) Patent Application Publication
(10) Pub. No.: US 2026/0072890 A1
(43) Pub. Date: Mar. 12, 2026

(54) GENERATING AND MANAGING SPARSE VECTORS IN A DATABASE SYSTEM

(71) Applicant: Oracle International Corporation, Redwood Shores, CA (US)

(72) Inventors: Aurosish Mishra, Foster City, CA (US); Shasank Kisan Chavan, Menlo Park, CA (US); Shubha Bose, Foster City, CA (US); Meenakshi Sundaram Arumugam, Belmont, CA (US); Weiwei Gong, Belmont, CA (US); James Kearney, Bolton, MA (US); Zhen Hua Liu, San Mateo, CA (US); Allison L. Holloway, San Carlos, CA (US)

(21) Appl. No.: 18/828,330

(22) Filed: Sep. 9, 2024

(51) Int. Cl. G06F 16/22; G06F 16/21

(52) U.S. Cl. CPC G06F 16/2237; G06F 16/219; G06F 16/2272

(57) ABSTRACT

Techniques for generating and managing sparse vector representations in a database system are provided. In one technique, an embedding that was generated by an embedding model is accessed. Based on one or more characteristics associated with the embedding, a particular storage format is selected from among multiple storage formats in which to store the embedding. A sparse vector representation is generated based on the embedding and the particular storage format. The sparse vector representation is stored. The sparse vector representation may be stored in the same VECTOR type column that stores sparse vector representations that are in different storage formats and/or dense vector representations.

### TECHNICAL FIELD

The present disclosure generally relates to vector storage and, more particularly, to generating and processing compact sparse vectors that have relatively few non-zero dimension values.

### BACKGROUND

A vector is a fixed length sequence of numbers, typically floating point numbers, such as [21.4, 45.2, 675.34, 19.4, 83.24], which is a five-dimensional vector. An embedding is a means of representing objects (e.g., text, images, and audio) as points in a continuous vector space where the locations of those points in space are semantically meaningful to one or more machine learning (ML) algorithms. An embedding is often represented as a vector. Generically, a vector embedding represents a point in N-dimensional space. Vector embeddings are intended to capture the important “features” of the data that the vector embeddings represent (or embed). The data a vector embedding represents can be one of many types of data, such as a document, an email, an image, or a video. Examples of features are color, size, category, location, texture, meaning, and concept. Each feature is represented by one or more numbers (dimensions) in the vector embedding. Hereinafter, a “vector embedding” is referred to as a “vector.”

Today, vectors are often generated by machine-learned models (e.g., neural networks) and the features they represent are often difficult for humans to understand. One way that vectors are produced by neural networks is by capturing the outputs of the neurons in the penultimate layer, i.e., the neural network's outputs just before the final processing layer.

### Distance Between Vectors

An important attribute of vectors is that the distance between two vectors is a good proxy for the similarity of the objects represented by the vectors. Two vectors that represent similar data should be a short distance from each other in vector space. The opposite is also true: dissimilar data are represented by vectors that are far apart from each other in the vector space. For example, the distance between a vector for the word “cat” and a vector for the word “dog” should be less than the distance the vector for the word “cat” and a vector for the word “plant.”

The distance between two vectors is often calculated by summing the squares of the difference between the numbers in each position of the vectors:

$$( Vector 1 [ 1 ] - Vector 2 [ 1 ] ) \hat{} 2 + ( Vector 1 [ 2 ] - Vector 2 [ 2 ] ) \hat{} 2 + …$$

The property that vector distance represents object similarity is what allows similar data to be found using a vector database. For example, when a vector representing a picture of a dog is searched for in a vector database, the nearest vectors will be those representing other dogs, not vectors representing plants.

### Vector Processing Workloads

Vector processing workloads (not to be confused with SIMD vector processing) have been used in Natural Language Processing (NLP), image recognition, recommendations, etc. Vector processing workloads have two sub-categories that require separate optimization strategies: indexing and searching. Regarding indexing, vector embeddings (or simply vectors) are indexed using approximate indexing techniques. Unlike B-tree indexes, a vector index returns many matching values ranked by similarity. Index creation and rebuild tend to be CPU intensive and are optimized for throughput.

Regarding searching, the stored vectors are searched using a class of algorithms known as “Similarity Search” or “Approximate Nearest Neighbor (ANN)” to find the closest vectors to a query vector. Search is designed to minimize CPU usage in order to minimize response time.

### Vector Processing Patterns

A vector similarity search is like interactive online transaction processing (OLTP) in that end-users submit vector queries and expect an instant reply. Vector similarity search requires millisecond response time to finding vectors that are close (represent similar data) even when the database in which the vectors are stored holds billions of vectors. An example query is “find products that are similar to this picture” [reference to a digital image].” Another example query is “find corporate documents that conceptually match this natural language prompt: [NL prompt].”

Providing fast response times requires using specialized vector indexes and fast algorithms for computing distances between vectors. In some use cases, there is a need to combine vector similarity search with relational data. For example, a query may ask for data about houses that match a natural language prompt, are valued at over $1M, are in zip code 94070, and whose owner recently declared bankruptcy. Also, there may be a need to be able to insert new vectors into a database, delete vectors from the database, and index the vectors in real time.

### Vector Databases

Early vector workloads often used flat files or object stores to store vectors. An application would read the vectors out of their backend repositories into memory and perform vector processing using third-party libraries, such as FAISS. Generative artificial intelligence (AI) has greatly increased the volume and processing needs for vectors. Generative AI requires support for much higher volume ingest and faster filtering and retrieval. A database with vector capabilities and built-in indexing is important for these applications.

### Sparse Vectors

“Sparse vectors” refer to vector embeddings that commonly have a large number of dimensions but very few non-zero dimension values. Such vectors are produced by sparse encoding machine-learned models, such as SPLADE, BM25, etc. Conceptually, one type of sparse vector is a vector where every dimension corresponds to a keyword in a certain vocabulary. (In contrast, each dimension in a dense vector carries some semantic meaning, whether individually or in combination with other dimensions.) For a given document, a sparse vector contains non-zero dimension values for the keywords (including term expansion, stemmed words, etc.) occurring in that document. For example, a BERT (Bidirectional Encoder Representations from Transformers) model has a vocabulary size of 30,522, and several sparse encoders generate vectors of this dimensionality.

Sparse vectors may be used in a hybrid search, which is an advanced search technique which leverages traditional text matching algorithms alongside modern vector-based semantic searches. This approach is especially useful when the embedding model is not trained on domain-specific data, where text-based search can often yield better results. By creating sparse vectors to represent text matching algorithms and combining them with dense vectors, higher search accuracy can be achieved. Therefore, it is crucial for a vector database system to support both sparse and dense vectors.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example vector database management system (VDBMS), in an embodiment;

FIG. 2 depicts an example vector object, in an embodiment;

FIG. 3 is an example process for retrieving a version of a vector from a vector object, in an embodiment;

FIG. 4 is a flow diagram that depicts an example process for storing multiple versions of a vector into a single vector object, in an embodiment;

FIG. 5 is a diagram that depicts an example row of a table with a vector column that contains references to versions of a vector, in an embodiment;

FIG. 6 is a flow diagram the depicts an example process for generating a sparse vector representation, in an embodiment;

FIG. 7 is a flow diagram that depicts an example process for determining a storage format for a sparse vector, in an embodiment;

FIG. 8 is a block diagram that illustrates a computer system upon which an embodiment of the invention may be implemented;

FIG. 9 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for managing sparse vectors in a database system are provided. In one technique, a sparse vector is represented as two arrays of values: (1) a dimension positions array that stores the positions of non-zero values in the vector and (2) a dimension values array that stores the non-zero values at those positions. A sparse vector may also store the total number of dimensions. In a related technique, a storage format is selected for a set of sparse vectors depending on one or more criteria, such as whether the sparse vectors are binary vectors, which distance functions will be used with the sparse vectors, and/or a count and distribution of non-zero dimension values across one or more of the sparse vectors.

Embodiments improve computer-related technology pertaining to vector storage. Instead of storing many zero value dimension values in a traditional dense vector, embodiments store sparse vectors that comprise minimal data for representing the zero value dimension values. Also, embodiments allow for the automatic and intelligent selection of an appropriate storage format in which to store each sparse vector.

### Vector Database System Overview

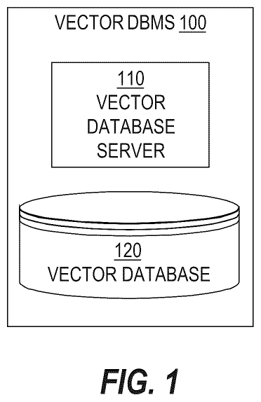

FIG. 1 is a block diagram that depicts an example vector database management system (VDBMS) 100, in an embodiment. VDBMS 100 comprises a vector database server 110 and a vector database 120. Vector database server 110 is communicatively coupled to vector database 120. VDBMS 100 may be deployed in a network of an enterprise or may be deployed in a cloud environment and, therefore, may be accessible to an enterprise over one or more computer networks (e.g., the Internet). VDBMS 100 may be provisioned for an enterprise by a cloud management team of a cloud provider as needed on an enterprise-by-enterprise basis.

Vector database server 110 comprises one or more computing machines, each executing one or more compute instances that receive and process data requests, including data retrieval requests (e.g., queries) and data modification requests (i.e., for vector data modifications), such as inserting vectors, deleting vectors, and updating vectors. A computing instance translates a data request into a storage layer request that the computing instance transmits to vector database 120. A computing machine that hosts at least one compute instance includes (1) one or more processors, (2) volatile memory for storing data requests (and their respective contents) and vector data that is retrieved from vector database 120, and (3) optionally, non-volatile memory.

Vector database 120 may comprise multiple storage devices, each storing vector data and, optionally, one or more non-vector data. For example, vector database 120 stores a table that includes a column for storing vectors and one or more column for storing user data, such as a column for storing a user identifier, a column for storing a user profile, a column for storing user search history, a column for storing user access history, a column for storing user-generated content, etc. In this example, each row in the table corresponds to a user, such as a customer, a subscriber to a service, etc.

Vector database 120 may also store one or more indexes that index content in vector database 120, such as content stored in one or more base tables. Some of the indexed content may be vector-related data (e.g., actual vector embeddings and metadata thereof) and some of the indexed content may be non-vector-related data, such as content in columns that do not store vectors. Thus, at least one index that vector database 120 may store is a vector index, described in more detail herein.

### Native Support for Vector Embeddings

In an embodiment, VDBMS 100 provides native support for a new vector embedding (“VECTOR”) datatype. The native support may include operators and indexes that are associated with that datatype. Examples of other datatypes that may be natively supported by VDBMS 100 include INT (integer), FLOAT (floating point), DATE, and STRING.

A VECTOR column may be defined with two values: a number of elements/dimensions and a dimension format (or “element type”). A generic example of VECTOR datatype syntax is the following:

```
  VECTOR(<Num Elements>, <Element Type>).
The following is an example is using this VECTOR datatype syntax to create a new table for
storing vectors:
  create table vector_tab (id NUMBER, attributes JSON, data VECTOR(768,
    ‘FLOAT32’))
where “id”, “attributes”, and “data” are names of columns of the table named “vector_tab.” The
first column in vector_tab is a NUMBER datatype, the second column in vector_tab is a JSON
datatype, and the third column in vector_tab is a VECTOR datatype.
```

Different types of functions may be supported as part of this new VECTOR datatype. Example functions include distance functions, aggregate functions, and single vector functions. An example distance function is “VECTOR_DISTANCE(vector1, vector2, <optional distance metric>).” This distance function computes a distance between vector1 and vector2 and is the most common operation forming the basis of similarity search. Distance metrics may be in Euclidean (which may be the default metric), cosine distance (1−cosine similarity), dot distance (negative of dot product), Manhattan, Hamming, etc. This distance function may return different types of values depending on the storage representation. For example, this distance function returns (a) a binary float value if the storage representation is four bytes or less or (b) a binary double value otherwise.

An example of an aggregate function is “VECTOR_AVG(VECTOR)” where VECTOR refers to the column and, thus, this function takes a set of vectors as input. This function computes the average vector across a set of vectors and returns a vector. This function is useful for Word2Vec use-cases (e.g., sentiment analysis across tweets) where every word has a vector and a sentence's vector is computed as the average vector of all words in the sentence or all keywords in the sentence.

Regarding single vector functions, two example functions are as follows: (1) “VECTOR_COUNT_DIMENSIONS(VECTOR),” which counts the number of dimensions in an input vector and returns a number; and (2) “VECTOR_NORM(VECTOR),” which computes the Euclidean norm/length of an input vector and returns a value, such as a BINARY DOUBLE.

The following are examples of queries (in structure query language (SQL) format) using the vector distance function:

```
  select id from vector_tab order by VECTOR_DISTANCE(data, :query) asc fetch first 5
    rows only;
This query compares the query vector (“:query”) with every vector in the table “tab” (where tab
has a column named “data” that stores vectors). While a result of this query is 100% accurate, it
is relatively slow.
  select id from tab t where t.attributes.year.number( ) < 2000
    order by VECTOR_DISTANCE(data, :query) asc fetch first 5 rows only;
This query results in obtaining the top five photos that are similar to a query photo (“:query”)
that were taken before the year 2000.
  with query as
    (select id, data from vector_tab where id = :id)
    select t.id from vector_tab t, query q where t.id != q.id order by
    VECTOR_DISTANCE(t.data, q.data) asc fetch first 5 rows only;
This query results in obtaining the top five nearest neighbors to a specific vector in a data set
(i.e., vector_tab).
  select id from vector_tab
    where VECTOR_DISTANCE(data, :query, ‘MANHATTAN’) < 5;
This query results in obtaining all neighbors that are within a threshold distance from the query
vector (“:query”), where the vector distance function specifies a specific distance metric (i.e.,
Manhattan), thus, overriding the default distance metric.
```

### Vector Storage

Because vectors that are produced by a ML model are of fixed length, an optimal type is used for underlying storage. For example, for vectors that are less than 8K elements in length, RAW may be used, which should handle most use cases. For larger vectors, binary large object (BLOB) may be used. BLOB should not be used for small vectors due to fixed overhead of LOBs. However, whether BLOB or RAW is used has no effect on the user interface.

In an embodiment, additional summary data may be kept within a vector in order to accelerate operations. For example, the squared norm of a vector (Sum(v²)), which is required for distance calculations, may be stored in a header of the vector. A vector may require additional metadata, such as vector version number, whether the vector stores IEEE floats or binary floats, etc.

### Vector Datatype: Flexible Type Specification

In an embodiment, the VECTOR datatype is specified with a flexible dimension count and/or a flexible dimension format. Supported dimension formats may include INT8 (1-byte integer), BINARY, FLOAT16, FLOAT32, FLOAT64, and BFLOAT16. An example of a support VECTOR datatype specification is the following:
VECTOR or VECTOR(*, *)

In the above example, both the dimension count and the dimension format are flexible. This allows the greatest flexibility. In this way, if another vector with a different dimension count or different dimension format is generated, that vector may be stored with other vectors of different counts and/or dimensions, without having to change any schema or applications that target vectors that are defined accordingly.
VECTOR(<dimension count>) or VECTOR(<dimension count>, *)

In the above example, the dimension count is fixed, but the dimension format is flexible.
VECTOR(*, <dimension format>)

In the above example, the dimension count is flexible (and could theoretically be any value), but the dimension format is fixed.
VECTOR(<dimension count>, <dimension format>)

In the above example, both the dimension count and the dimension format are fixed. A specific example of using the VECTOR data type when creating a table is the following:
create table vectab (id number, c VECTOR(1024, FLOAT32))
   where c is the name of a column of datatype VECTOR.

An advantage of a flexible specification is that API calls are easier, since only the VECTOR name needs to be passed without having to specify number of dimensions and/or dimension format.

Another advantage of a flexible specification is that it allows a user (e.g., a database administrator) to evolve the contents of a VECTOR column over time easily. There are a wide range of embedding models with different dimension counts and dimension formats that can be chosen to vectorize user data. For example, Open AI Text-Ada-002 produces vectors of 1536 dimensions of FLOAT32, Cohere Embed-English-v3.0 produces vectors of 1024 dimensions of FLOAT32, and Alibaba's gte-small-ct2-int8 produces vectors of 384 dimensions of INT8. A user may desire to try out vectors from various models and judge the quality of semantic search results before finalizing a model. Having a flexible specification allows a user to keep the schema consistent while changing the content stored in the vector column.

Often the user may choose to partition the data in a table by some relational attributes and each partition can contain vectors of different dimension counts or formats. For example, a user may choose to partition a BOOKS table by the GENRE column. Certain genres like Fiction or Economics might be more popular than genres like Biography. Books of the more popular genres can be vectorized using higher dimension vectors while less popular genres can be vectorized with lower dimension vectors. Using higher dimension vectors to improve searches implicitly assumes that higher dimensional vectors capture more “semantic information.” Thus, higher dimension vectors may be used to find matches to a wider array of user searches.

A disadvantage of having flexible dimension counts is that vector distance computations cannot be blindly performed on a column containing vectors of different dimension counts. For example, in the book genre example above, a user must add a predicate on the GENRE column to ensure that the search vector is being compared with vectors of the same dimension count.

However, vector distance operations may be executed on two vectors of different dimension formats. For example, using a new SQL function VECTOR_DISTANCE( ), a distance computation may be performed between a three-dimensional vector of FLOAT32 and a three-dimensional vector of FLOAT64. The following is an example of a data definition language (DDL) statement, a data manipulation language (DML) statement, and a structure query language (SQL) statement, respectively:

create table vectab (c1 vector(3, FLOAT32), c2 vector(3, FLOAT64));
insert into vectab values (TO_VECTOR(‘[1.15, 2.27,
3.34]’, 3, FLOAT32),
TO_VECTOR(‘[1.234, 2.234, 3.334]’, 3, FLOAT64));
select vector_distance(c1, c2) from vectab;

Internally, vectors with the lower precision dimension format are upconverted to the higher precision format and then the distance computation is performed. This ability adds to the advantages of flexibility described earlier.

### Vector Datatype: Flexible Storage Format

In an embodiment, vectors are stored in objects, such as large objects (LOBs), an example of which is a binary LOB (BLOB). Storing vectors in LOBs allows for storing large vectors, such as vectors with dimensions up to 65,534 dimensions.

In an embodiment, an object that stores a vector is designed to be self-contained, meaning each vector object contains information about the dimension count and/or dimension format of the corresponding vector. This allows any module or application to examine a vector object and precisely interpret the vector without relying on a separate dictionary/catalog table that describes the datatype.

In a related embodiment, the format of a vector is designed to cache additional metadata that can be used to accelerate distance computations during run-time. One such metadata is the Squared L2-Norm (Euclidean Norm) of a vector, which norm can be used to speed up Euclidean distance calculations. Given two vectors v1: (x1, y1) and v2: (x2, y2), the Euclidean distance between the two vectors is sqrt((x1−x2)\hat{ }2+(y1−y2) \hat{ }2). The portion inside the sqrt( ) can be expanded as: x1\hat{ }2+x2\hat{ }2−2x1x2+y1\hat{ }2+y2\hat{ }2−2y1y2=(x1\hat{ }2+y1\hat{ }2)+(x2\hat{ }2+y2\hat{ }2)−2(x1x2+y1y2)=Squared_Norm(v1)+Squared_Norm(v2)−2(x1x2+y1y2). Thus, for a given query vector, a one-time computation of the Squared Norm may be computed and, if each vector in a table already has the Squared Norm cached, then the distance computation cost is reduced by approximately 10%.

The format of a vector is designed to store the vector's data, including floating point dimension formats, in either IEEE754 format or a proprietary canonical binary float/double format that allows for floating point numbers to be byte-comparable. An example vector format is as follows:

```
[Version # (1B)][Flag (2B)][Num_Dims (1B/2B/4B)][Storage Type
  (1B)][Squared L2-Norm (1B/2B/4B/8B)][Vector Data
  (1B/2B/4B/8B)*num_dims]
```

where each ‘[ ]’ corresponds to a field in a vector, ‘B’ refers byte, ‘1B/2B’ means that the corresponding field in a vector may be one byte or two bytes in length, ‘Num_Dims’ refers to number of dimensions, example storage types include FLOAT32 and INT8, and L2-Norm is the Euclidean distance between the vector and the “zero” vector (or origin). Calculating and storing the L2-Norm value within a vector object reduces the time to compute a distance between the vector and another vector.

### Versioning of Vectors

An important piece of an AI Vector Search eco-system is the ability to update the embedding model that is used to vectorize (e.g., unstructured) data. As this space is rapidly evolving, it is possible that embedding models of the future produce vectors of different dimension counts and/or different dimension formats. Having a flexible VECTOR column type allows users to update the vector column by replacing vectors from an old model with a new model. While functionally valid, this approach may prove to be expensive, especially for large datasets with hundreds of millions of vectors. In particular, all vectors in the table for a specific column must be updated with vectors from the new model in a single transaction before new searches can leverage them. Such an update could take hours.

Also, users may want to experiment with different embedding models to decide which model's vectors provide the best semantic search quality. One idea is to create multiple columns, one for each embedding model. However, this requires creating multiple versions of the application that references different vector columns in Top K queries.

In an embodiment, multiple versions of a vector are stored in the same object. Storing multiple versions of a vector in the same object addresses problems of both approaches (of (i) replacing old vectors with new vectors and (ii) creating a column for each embedding model). An object may be a LOB (or large object), an example of which is a binary LOB (BLOB). Relatively small vectors may also be stored in RAW columns.

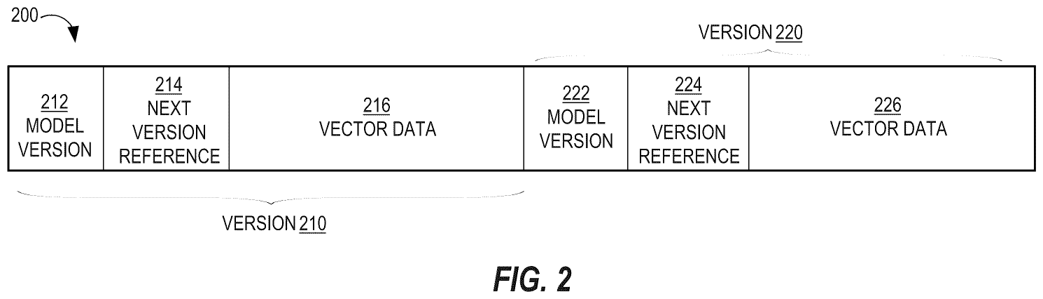

From a storage perspective, there are two main options to store multiple versions of a vector in a single object (e.g., a BLOB): (1) storing the different versions in a linked-list style format within the BLOB format and (2) leveraging vector-only extents. Regarding the first option, FIG. 2 depicts an example vector object 200, in an embodiment. Vector object 200 comprises two versions (210 and 220) of a vector. Data for each version comprises three fields: a model version number, a next version reference that points to the next version in the same object, and the vector data itself of that version. Therefore, data for the first version 210 comprises model version number 212, next version reference 214 (which references version 220), and vector data 216. Similarly, data for the second version 220 comprises model version number 222, next version reference 224, and vector data 226. Vector data 216 stores the embedding data for version 210 while vector data 226 stores the embedding data for version 220.

Thus, a next version reference field stores a value that indicates a location where data about another version is stored. The value may be a byte offset into the version object. The last (in order) version in a vector object may have a value of zero or null in its next version reference field, which value indicates that there are no more versions of the vector that follow that last version.

The model version number of a version may be a number that is automatically set by the process (e.g., a version adding component) that inserts the version into a vector object. The model version number may be a monotonically increasing value. For example, the first version of a vector is assigned model version ‘0’, the second version of the vector is assigned model version ‘1’ and so forth. Alternatively, the model version number may be (a) a value that corresponds to the embedding model that generated the version or (b) a name of that embedding model. In either scenario, vector database 120 stores a mapping (which may be read into memory of vector database server 110) that maps embedding model names/identifiers to their respective model version numbers that are stored in vector objects in vector database 120.

### Versioning of Vectors: Retrieving a Version

A version retrieval component retrieves one or more versions of a vector from a vector object. The version retrieval component may be implemented in software, hardware, or any combination of software and hardware. The version retrieval component may be part of a vector database server 110 and may be called by a vector search application. Alternatively, the version retrieval component may be part of a storage sub-layer that is distinct from a database server layer that receives vector search queries. For example, the version retrieval component may be part of vector database 120. The more processing that is pushed to vector database 120, the less data that needs to be transferred to vector database server 110.

The version retrieval component may determine which version(s) to retrieve based on one or more inputs (e.g., from a user or a vector search application). For example, a user specifies which version of a vector is desired, such as “version0,” “version1,” “3,” etc. A version specification may be passed as input to an application that processes versioned vectors.

Additionally or alternatively, the version retrieval component retrieves the most recent version of a vector by default. Thus, no input specifying which version(s) to retrieve may be necessary. In this way, if a user/application does not specify a version number, then it is presumed that the user/application desires the most recent version.

In a related embodiment, new SQL syntax is provided to allow users to specify which version of a vector is desired. For example, the vector distance function may be augmented to allow for flexible version specification, such as the following:

VECTOR_DISTANCE(<vec_col1>, <vec_col2>, <distance metric>, <version number of
vec_col1>, <version number of vec_col2>)

The version numbers may be bind values that an application can change.

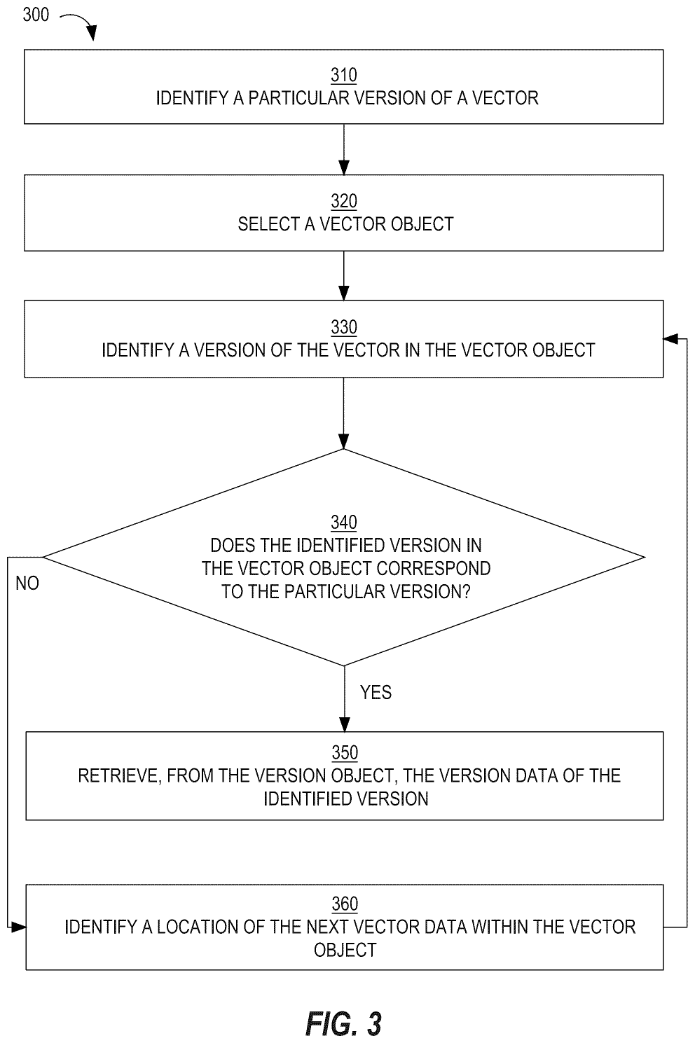

FIG. 3 is an example process 300 for retrieving a version of a vector from a vector object, in an embodiment. Process 300 may be performed by a version retrieval component.

At block 310, a particular version of a vector is identified. The particular version may be specified by a user. Alternatively, the particular version may be a default version, such as the oldest version or the newest (or most recent) version. Different API calls to the version retrieval component may indicate which version. For example, one API call may be associated with a request to retrieve the oldest version of a vector while another API call may be associated with a request to retrieve the newest version of a vector. Alternatively, only a single API call is used to initiate the version retrieval component and one or more values that are passed as part of the API call indicate which version(s) to retrieve.

At block 320, a vector object is selected. Block 320 may involve selecting multiple vector objects. A vector object may be selected based on applying one or more search criteria to one or more columns of a table that stores vectors. Block 320 may be performed before or after block 310.

At block 330, a version in the vector object is identified. The first iteration of block 330 may involve identifying the first version (sequentially speaking) in the vector object. The second iteration of block 330 may involve identifying the next version in the vector object, which is after the first version, using the next version reference field value identified in block 360.

At block 340, it is determined whether the identified version in the vector object corresponds to the particular version that was identified in block 310. Block 340 may involve comparing the particular version (identified in block 310) with the value in the model version field of the identified version. If the determination in block 340 is in the affirmative, then process 300 proceeds to block 350. Otherwise, process 300 proceeds to block 360.

At block 350, the version data of the identified version is retrieved from the version object. The version data may be identified based on (1) first data that indicates an offset into the vector object where the version data begins and (2) second data that indicates a length (e.g., in bytes) of the version data. Thus, the vector data between (a) a first location indicated by the first data and (b) a second location indicated by a combination of the first data and the second data (e.g., first data+second data) is retrieved.

After block 350, if multiple versions of the vector are requested, then process 300 may return to block 310 where another version is identified. For example, a request to the version retrieval component may specify versions 4 and 5 or the second version and the most recent version. Therefore, process 300 may be performed once for each requested version.

At block 360, a location of the next vector data within the vector object is identified. This location may be identified using the value in the next version reference field of the identified version (identified in block 330). Process 300 then returns to block 330. However, if the value in the next version reference field indicates that there are no versions, then process 300 may return an error or return a value indicating that the particular version is not available.

In a scenario where the version retrieval component receives a request to identify and return the most recent version of a vector from a vector object and the most recent version is stored at the beginning of the vector object at a position that is known without having to scan the vector object (e.g., because the first version in a vector object is always stored at offset six bytes from the beginning of the vector object), then identifying the most recent version involves identifying that byte offset into the vector object and returning the bytes between (1) the byte offset and (2) a location identified by the sum of (i) the byte offset and (ii) the length of the vector data of the most recent version.

### Versioning of Vectors: Deleting Particular Versions

In an embodiment, a request or instruction is received to delete a particular version of multiple vectors. For example, a software engineer may decide that the embedding model that generated the most recent versions of a set of vectors performed poorly in one or more tests. In order to free up space in non-volatile, or persistent, storage, the most recent versions of the set of vectors are deleted.

Deleting a particular version of a multiple vectors may involve receiving an instruction that indicates the particular version (e.g., the first version or the most recent version or a value that indicates a particular number). The instruction may also specify a table or a column within the table that stores the vectors. In this way, the set of vectors involved may be inferred. For each vector object in the table or column, a version deletion component (e.g., of vector database server 110 or of vector database 120) determines the version in the vector object (logical or physical, which is described in more detail herein) that matches the particular version and either (i) deletes the embedding data of that version or (ii) sets a flag that indicates that the space occupied by the embedding data is reusable. If future versions are expected, then approach (ii) may be preferred since the space has already been allocated.

In a related embodiment, an instruction or request to delete may specify or otherwise indicate multiple versions. For example, an instruction may be to delete versions two and four, or to delete the last two versions.

### Versioning of Vectors: Adding New Versions

In an embodiment, adding a new version to a vector object that comprises one or more versions involves appending the new version to the one or more versions. Such adding is efficient with relatively low overhead. Adding a new version may involve traversing one or more next version reference fields in a vector object. For example, once a version object is identified, a version adding component identifies a next version reference field in the data for the first version (sequentially) in the version object. The version adding component uses the value in the next version reference field to identify the second version (sequentially) in the vector object, if the second version exists. This process continues until the version adding component identifies, within the vector object, a next version reference field that contains a value that indicates that there are no more versions in the vector object. The version adding component identifies a position within the vector object to which the new version may be added. That position is the byte that follows the last byte of vector data in the vector object.

In adding a new version of a vector to a vector object, the version adding component also adds a value to a model version number field for the new version, the value indicating the version of a model that generated the new version. The version adding component may also add a value for the next version reference field. When appending a new version to a version object, this value may be zero or null, indicating that there are no more versions after this new version.

However, appending versions to one or more versions in a vector object may cause (due to data block size limitations) the most recent version to be stored in a different data block than the data block that stores the one or more versions. Therefore, when retrieving the most recent version, a version retrieval component must follow one or more references to arrive at the different data block to retrieve that version. Accessing two or more data blocks to retrieve the proper version of a vector may increase latency substantially. Fitting as many versions of a vector into a single data block is preferrable for use cases where there is significant traversing of versions involved.

In a related embodiment, a vector object includes a most recent reference field that includes a reference or pointer to the most recent version of the vector represented by the vector object. This most recent reference field may be the first field in the vector object or one of the first few fields in the vector object, which field may be easily and quickly identifiable, such as N bytes from the beginning of the vector object. In this way, retrieving the most recent version of a vector may only require following at most one reference, even though there may be many versions of the vector that are stored in the vector object.

In another embodiment, a new version is prepended to a vector object that comprises one or more versions. Such prepending may require shifting existing contents of the vector object to later offsets or positions within the vector object. Shifting may comprise copying existing contents (e.g., vector data of multiple versions of a vector, model version numbers, and next version reference values) of the vector object, determining a byte offset in the vector object, and storing the copied contents beginning at the byte offset, whether in the same data block or a new data block. Determining the byte offset may involve determining the size (e.g., in bytes) of the new version, determining the size (e.g., in bytes) of any required fields that are to accompany the new version (such as a model version number field and a next version reference field) and totaling/summing those two sizes to compute the byte offset.

Prepending a new version to a vector object also involves generating a value for a next version reference field of the new version and storing that value in that next version reference field. The value in this next version reference field points to the most recent version (before the new version) that was added to the vector object. The first time a version of a vector is stored in the vector object, the value of the next version reference field may be zero or null, indicating that there are no more versions sequentially after the first version is added to the vector object. Thereafter, the value of the next version reference field for the new version may be the size of the new version plus zero or more pre-defined offsets.

Similarly, for inserting vectors, new DDL may be used to specify the version into which to insert the vectors. There are at least two techniques to specify which version is to be updated or retrieved. A first technique is to use a SQL construct to specify which version is of interest. For example, in order to update a value of the fourth version of a vector using JSON-like interpretation, the following statement may be used:

$$update mytab set veccol = VECTOR\_TRANSFORM ( veccol , SET {{}^{‵} \$ [ 4 ]}^{′} = {}^{‵} {[ 1.1 , 2.2 , … ]}^{′} )$$

As another example, in order to retrieve the third version using JSON-like interpretation, the following statement may be used:
select FROM_VECTOR(VECTOR_VERSION(veccol, ‘$[3]’)) from mytab;

A second technique is to create a DDL that defines the currently accepted version across sessions. For example, in order to make the third version the default version for any application that accesses the corresponding column, the following statement may be used:
alter table mytab modify column (veccol current_version 3);
   With this added metadata associated with the vector column, when inserting vectors into that column, the following statement may be used to automatically update vector column payloads to add the third version:
insert into mytab values (‘[3.1, 3.2, 1.0]’);

An advantage with this embodiment is that the new vectors can be added in a rolling/online fashion where the application can continue to use old vectors while the new vectors are added over time.

### Process Overview

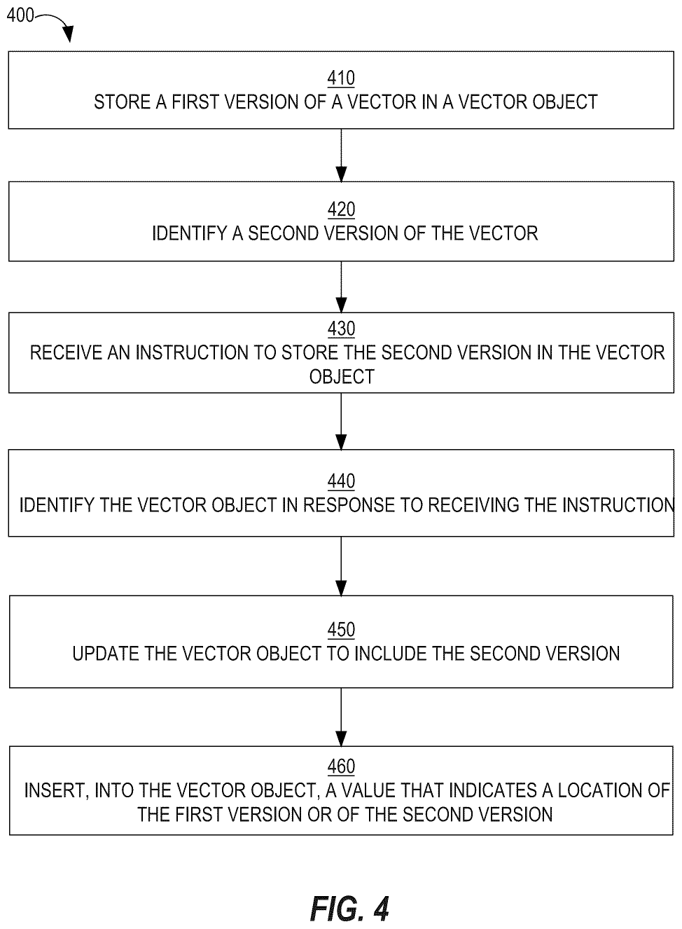

FIG. 4 is a flow diagram that depicts an example process 400 for storing multiple versions of a vector into a single vector object, in an embodiment. Process 400 may be performed, at least in part, by the version adding component, which may be part of vector database server 110 or vector database 120.

At block 410, a first version of a vector is stored in a vector object. The first version may have been generated by a first embedding model (e.g., a neural network) and stored in a row of a table with a column for storing objects of the VECTOR datatype. The vector object may be a BLOB object.

At block 420, a second version, of the vector, is identified. The second version is different than the first version and is not yet stored in the vector object. The second version may have been generated by a second embedding model after the vector object was created and after the first version of the vector was stored in the vector object. Block 420 may involve identifying the second version immediately after the second version is generated.

At block 430, an instruction to store the second version in the vector object is received. The instruction may have originated from a storage application that transmitted the instruction to a vector database server, such as a vector database server 110. Alternatively, the instruction may originate from the vector database server and be received at a storage layer of vector database 120.

At block 440, in response to receiving the instruction, the vector object is identified. The instruction may include a row identifier that uniquely identifies a row in which the vector object is stored. Alternatively, the instruction may include other data (such as a combination of data values) that is used to uniquely identify a row.

At block 450, the vector object is updated to include the second version in addition to the first version. Block 450 may involve appending, within the vector object, the second version to the first version. Alternatively, block 450 may involve prepending the second version to the first version.

At block 460, a value that indicates a location, within the vector object, of the first version or of the second version is inserted into a next version reference field of the vector object. Block 460 may be part of block 450 in that, during the update, other data may be inserted into the vector object. Other data may include this value for a next version reference field, as well as a model version number (or identifier) that identifies (and/or is mapped to) an embedding model that generated the second version.

### Vector-Only Extents: Logical Vector Objects

As noted above, there are two main options to store multiple versions of a vector. FIG. 2 depicts a first main option (i.e., a linked-list style format) while vector-only extents are a second main option. An extent is a logical unit of database storage space allocation made up of a number of contiguous data blocks.

In an embodiment, the versions of a vector object may be physically stored in one or more vector extents, where a vector-only extent only contains vector data, including a vector embedding of a version of a vector. Thus, each vector version is stored in blocks allocated for vector-only extents. A vector-only extent might store vector versions from different vector objects. For example, vector-only extent E1 stores {Vector Object #1, Version #1}, {Vector Object #1, Version 2}, {Vector Object #2, Version 2}, and another extent E2 stores {Vector Object #1, Version 3}, {Vector Object #2, Version 1}, {Vector Object #2, Version 3}.

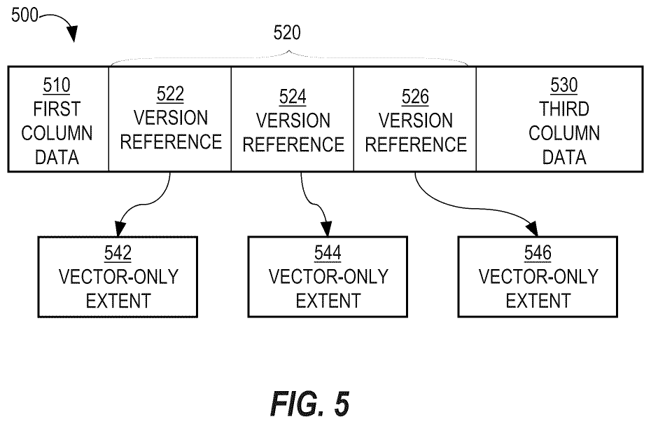

FIG. 5 is a diagram that depicts an example row 500 of a table with a vector column 520 that contains references 522-526 to versions of a vector, in an embodiment. Row 500 includes a first column 510 (e.g., a name), vector column 520 (which is the second column in the table), and a third column 530 (e.g., an employment start date). The contents of first column 510 are stored in first column 510, the contents of third column 530 are stored in third column 530, but the vector embeddings associated with vector column 520 are stored in one or more vector objects (or “vector-only extents”) that are stored separate from vector column 520. Instead, vector column 520 stores version references 522-526, each referencing a separate version of a vector. Each separate version of the vector is stored in a different (physical) vector-only extent, i.e., vector-only extents 542-546. Thus, a single row in the table comprises contents from first column 510, a set of versions references, and contents from third column 530.

A single vector-only extent may store multiple vector embeddings of one or more vectors. For example, the first two versions of a vector are stored in one vector-only extent, while a third version of the vector is stored in a different vector-only extent.

In this embodiment, vector column 520 does not physically contain vector embedding data (which is stored in vector-only extents 542-546), only non-vector embedding data, such as version references 522-526.

In a related embodiment, vector column 520 also stores a model version number for each version reference. These model version numbers may be used by a version retrieval component to identify the requested version of a vector. Similar to the process above for adding new versions of a vector to a vector object, when new versions are added to a logical vector object, version references associated with the versions may be appended to one or more existing version references in the logical vector object, prepended to the one or more existing version references, or added using a different technique.

In this embodiment where a version column contains version references instead of the actual vector embeddings, because many version references may fit into a single column, a version retrieval component must follow at most a single version reference to retrieve a vector-only extent that contains the vector embedding data for a requested version of a vector.

### Sparse Vector

In an embodiment, a sparse vector is a vector that has a high percentage of zero values for dimension values, such as over 50% or even over 95%. Thus, a sparse vector may include a number of dimension values that is much less than all the dimension values that the sparse vector represents.

A sparse vector may be represented in a number of different formats. In a first format, a sparse vector representation includes three sets of values: (1) a dimension count that indicates a number of dimensions of the vector (which dimension count may be optional); (2) a set of one or more position values (e.g., in the form of an array), each position value indicating a position, within the vector, of a non-zero dimension value; and (3) a set of one or more non-zero dimension values (e.g., in the form of an array). For example, a sparse vector representation with the following values “[7, [1, 3, 5], [1.0, 2.0, 3.0]]” indicates that the vector has seven dimensions, that the vector has non-zero values at positions 1, 3, and 5 (and, therefore, zero dimension values at positions 2, 4, 6, and 7), and that the non-zero values at those respective positions are 1.0, 2.0, and 3.0.

In a second format, a sparse vector representation is an array of key-value pairs, where the “key” in a key-value pair is the position of a corresponding non-zero dimension value and the “value” in the key-value pair is the non-zero dimension value. The second format is described in more detail herein.

In a third format, a sparse vector representation comprises an array of positions of the non-zero dimension values. This sparse vector representation does not include any non-zero dimension values. This works for binary vectors where the only possible dimension values are 0 and 1.

In a fourth format, a sparse vector representation comprises a dimensions position array that is delta encoded. This fourth format may be a variant of the first format, the second format, or the third format. For efficient delta encoding, the set of position values should be contiguous. Therefore, delta encoding the position values in the array of key-value pairs is not as efficient. Delta encoding is described in more detail herein. Hereinafter, “sparse vector representation” is used interchangeably with “sparse vector.”

### Type Specification

In an embodiment, a sparse vector representation is specified by extending a flexible VECTOR type as follows:
VECTOR([dimension count], [dimension format], [SPARSE|DENSE])

The third parameter is used to indicate a sparse type or a dense type of vector. In a related embodiment, either the SPARSE type or the DENSE type is a default value for this parameter. For example, if DENSE is the default value, then if no value is specified for this third parameter, then the resulting vector data type is treated as a dense vector. Such a default may be used to remain backwards compatible.

An example of using this sparse type specification in a DDL statement is the following:
create table mytab (id NUMBER, data VECTOR(1024, FLOAT32, SPARSE))
   In this example, vectors that will be stored in the data column of the mytab table will have 1024 dimensions, have a dimension format of FLOAT32, and be of type SPARSE.

An alternate specification is to indicate “SPARSE-ness” through an Annotation as follows:

create table mytab (id NUMBER, data VECTOR(1024, FLOAT32) ANNOTATIONS
(format ‘SPARSE’)

In an embodiment, a SPARSE vector may also be of type Flexible, meaning that either the dimension count or the dimension format (or both) of sparse vectors may vary from one vector to another in the same VECTOR column. An example of a flexible VECTOR specification with a sparse type is the following:
create table mytab (id NUMBER, data VECTOR(*, *, SPARSE))

In this example, a vector is not limited to a single dimension count or to a single dimension format. For example, if there are five possible dimension formats, then vectors that are store in the “data” column may have any one of those five dimension formats. This flexible specification allows users to insert vectors from different sparse encoding models into the same column. As with dense vectors, users may specify a different relational column (e.g., MODEL_ID) to distinguish between vectors obtained from different models for meaningful Top K vector distance computations.

### Inserting Sparse Vectors

In an embodiment, sparse vectors are represented with strings. This is useful for certain applications, such as SQLPlus, SQLDeveloper, etc. An example of an insertion is the following:

create table mytab (id NUMBER, data VECTOR(5, FLOAT32, SPARSE))
INSERT INTO mytab (data) VALUES (′[5, [1,3,5], [1.0,2.0,3.0]]’);

In this example, the sparse vector, when fully described, is: [1.0, 0, 2.0, 0, 3.0]

This compact string representation only represents the non-zero dimension positions and values. This string representation is valid JSON (JavaScript Object Notation) which allows for seamless usage across applications, which can leverage existing JSON APIs (application programming interfaces) to access different elements of the array. For example, j[1] refers to the first element in a sparse vector representation named ‘j’ (which element may be the number of dimensions in the sparse vector), j[2] refers to the second element in the sparse vector representation (which may be the dimension positions array), and so forth. Additionally, in this example, j[2] [3] refers to the third element in the dimension positions array.

The first array element “5” indicates the maximum number of dimensions of the model that generated the sparse vector. This allows the database to make meaningful distance computations for Top K search between vectors that have the same maximum dimension count (i.e., generated by the same model) and avoids performing distance computations across sparse vectors generated by different models. In a related embodiment, this first array element is optional, especially when inserting into a fully-defined VECTOR column. For example, the “data” column in “mytab” is already specified as supporting a maximum of five dimensions.

The second array element is an array indicating the non-zero dimension positions, while the third array element is an array indicating the non-zero dimension values.

In an embodiment, for maximum flexibility, users can insert sparse vectors in DENSE format as well. For example:
INSERT INTO mytab (data) VALUES (‘[1.0, 0, 2.0, 0, 3.0]’);

In an embodiment, users can perform various conversions to/from sparse vectors using a constructor, such as the VECTOR( )/TO_VECTOR( ) constructor. For example, in order to convert a sparse vector to a dense vector, the TO-VECTOR( ) constructor may be used as follows:
TO_VECTOR(‘[5, [1,3,5], [1.0,2.0,3.0]]’, 5, FLOAT32, DENSE)
   In this example, a sparse vector (i.e., represented as [5, [1,3,5], [1.0,2.0,3.0]) is converted to a dense vector that has a dimension count of five and a dimension format of FLOAT32.

Converting a sparse vector to a dense format may be performed in one or more ways. For example, an array of dimension values is generated where each entry in the array has an initial value of ‘0’ and the size of the array is the dimension count of the sparse vector. Then, the dimension positions array of the sparse vector is analyzed to identify each position value. For each position value, the corresponding entry in the dimension values array is identified and the value in that corresponding entry is retrieved and inserted into the newly generated array of dimension values at a position corresponding to the position value. After all the position values in the dimension positions array are processed, the newly generated array becomes a dense version of the sparse vector.

As another example, in order to convert a sparse vector in one dimension format to a sparse vector in another dimension format (e.g. from FLOAT32 format to FLOAT64 format):

TO_VECTOR((TO_VECTOR(‘[5, [1,3,5], [1.0,2.0,3.0]]’, 5, FLOAT32, SPARSE)), 5,
FLOAT64, SPARSE)

As another example, a sparse vector in one dimension format is converted to a dense vector in another dimension format. Other combinations of conversion from dense vectors to sparse vectors are possible.

### Fetching Sparse Vectors

In an embodiment, sparse vectors are retrieved either in sparse or dense format using a particular function, such as FROM_VECTOR( ) or VECTOR_SERIALIZE( ). For example, a sparse vector is retrieved in sparse format (which may be default behavior):
FROM_VECTOR(data RETURNING VARCHAR2 FORMAT SPARSE)

Other data types in which a vector may be returned other than variable character (or “VARCHAR2”) include JSON and CLOB (character large object). This flexibility in the data type in which a vector may be returned allows for different applications to process vectors in a format that the applications are expecting. For example, an application may be written to process vectors that are in a JSON format. Such an application may reference elements of a sparse vector ‘j’ as j[0], which refers to the maximum dimension count of sparse vector ‘j’, j[1] refers to the dimension positions array of that vector, j[2] refers to the dimension values array of that vector, j[1][i] refers to the ith element of the dimension positions array, and j[2][i] refers to the ith element of the dimension values array.

As another example, a sparse vector is retrieved in dense format:
FROM_VECTOR(data RETURNING VARCHAR2 FORMAT DENSE)

Such conversions allow flexible support across a wide variety of client drivers that may or may not have sparse vector support, even though a database server (e.g., of VDBMS 100) has sparse vector support.

### Storage Format: First Format Option

In an embodiment, the storage format for sparce vectors is designed to be flexible and performant for different distance computations. As described herein, there are four possible storage formats. The first storage format (as described herein) comprises (1) a position array storing positions of non-zero dimension values and (2) a dimension value array storing non-zero dimension values, and the position of each non-zero dimension value in the dimension value array corresponds to a position in the positions array. Thus, the value in the first position of the position array is a position, in a dense (or “regular”) embedding, of the value in the first position of the dimension value array, the value in the second position of the position array is a position, in the dense (or “regular”) embedding, of the value in the second position of the dimension value array, and so forth.

In this first storage format, the non-zero dimension position array can represent the positions as a single byte (1B) (for up to 255 dimensions), two bytes (2B) (for up to 65535 dimensions), or four bytes (4B) (for up to four billion dimensions). Similarly, each dimension value in the dimension values array can be 1B (for INT8 sparse vectors), 2B (for FLOAT16 and BFLOAT16 sparse vectors), 4B (for FLOAT32), or eight bytes (8B) (for FLOAT64).

An example data layout of this first example storage format is as follows:

[Magic (1B)][Version# (1B)][Flag1 (1B)][Flag2 (1B)][Dim Format (1B)][Num Dims
(4B)][Squared L2-Norm (8B)][Num Non-Zero Dims (2B)][<non-zero dim position
array> (1B/2B/4B each array entry)] [<non-zero dim value array> (1B/2B/4B/8B each
array entry)]

In this example data layout, there are optional fields for storing different values, such as a Magic field, a version number field (if a vector object can store multiple versions of a vector), two flag fields, and a dimension format field for indicating the dimension format. If the dimension format is constant in an implementation, then this “Dim Format” field is optional.

In this first storage format, dot distance (or the negative of dot product), cosine distance (or 1−cosine similarity), and hamming distance computations may be optimized. For example, a dot distance between two vectors is the sum of the product of their respective dimension values. At a high level, an algorithm for computing the dot distance of two vectors involves (1) finding the intersecting non-zero dimension positions between the two vectors from the dimension position array and then (2) for those intersecting positions, performing the product of dimension values and updating a running sum. In an embodiment, this operation is optimized with SIMD (single instruction, multiple data) instructions. Because the dot distance is only interested in dimension values at intersecting positions, the representation of separate arrays for dimension positions and dimension values is the most efficient, at least relative to the storage format that involves storing key-value pairs. Analyzing two sets of key-value pairs from different vectors may require accessing multiple cache lines, increasing the time to find intersecting positions. In contrast, analyzing two positions arrays (which do not contain any dimension values) is less likely to require accessing multiple cache lines.

Cosine distance is a measure of similarity between two non-zero vectors defined in an inner product space. Cosine distance is the cosine of the angle between the vectors. In other words, it is the dot product of the vectors divided by the product of their lengths. Cosine distance does not depend on the magnitudes of the vectors, but only on their angle. Cosine distance may be defined as (1−(DOT(V1, V2)/(NORM(V1)*NORM(V2))), where DOT( ) refers to the dot product function and NORM( ) refers to the norm function, which returns, given a vector as input, the square root of the sum of the squares of the entries of the vector. Therefore, computing the cosine distance may take advantage of the same technique as the dot product distance.

Hamming distance measures the number of dimension positions where the two vectors have different values. At a high level, computing the hamming difference between two vectors involves four main steps. First, the intersecting non-zero dimension positions between the two vectors are identified. The number of these intersecting positions is referred to herein as I_COUNT. Second, the union of non-zero dimension positions between the two vectors are identified. The number of positions in this union is referred to herein as U_COUNT. Third, for the intersecting non-zero dimension positions, check if the dimension values at those intersecting positions are different. The count of such positions where the position values are different is referred to herein as D_COUNT. The Hamming distance is defined as U_COUNT−I_COUNT+D_COUNT. This hamming distance operation may be performed efficiently with SIMD instructions.

### Storage Format: Second Format Option

A second storage format option stores the non-zero dimension values as an array of key-value pairs, such as (dimension position, dimension value). The dimension positions may be represented as 1B, 2B, or 4B, depending on the number of non-zero dimension positions. The dimension values may be in various formats, such as INT8 (or 8-bit integer), FLOAT32, and FLOAT64.

An example data layout of this second storage format option is similar to the data layout of the first storage format option and an example is as follows:

[Magic (1B)][Version# (1B)][Flag1 (1B)][Flag2 (1B)][Dim Format (1B)][Num Dims
(4B)][Squared L2-Norm (8B)][Num Non-Zero Dims (2B)][array of key-value pairs of
non-zero dimensions: (dim_pos1, dim_val1), (dim_pos2, dim_val2),...]

Thus, instead of two fields for storing a non-zero dimension position array and a non-zero dimension value array, there is a single field for storing an array of key-value pairs of non-zero dimensions.

This second storage format can optimize Euclidean, Manhattan, and Euclidean Squared distance computations, because each of these distance computations involves taking into account each non-zero dimension value, regardless of whether the two vectors have non-zero dimension values at the same position in their respective vectors. For example, the Euclidean distance between two vectors v1 and v2 may be defined as follows:

$$sqrt ( {( {v1\_d}_{1} - {v2\_d}_{1} )}^{2} + {( {v1\_d}_{2} - {v2\_d}_{2} )}^{2} + … {( {v1\_d}_{n} - {v2\_d}_{n} )}^{2} )$$

where vᵢ_dᵢ is the i^{th} dimension value for vector vᵢ.

A high level process for computing the Euclidean distance is as follows. First, iterate over the dimension positions. If a dimension position is present in both vectors, then perform the difference in corresponding dimension values, square the difference, and add the squared difference to a running sum. If the dimension position is present in only one vector, then the corresponding dimension value is squared to generate a result and the result is added to the running sum. Because the Euclidean distance is based on every non-zero dimension value for both vectors, the key-value pair storage is a more efficient storage representation. Similar logic applies to the Euclidean squared distance computation and the Manhattan (or “Taxicab”) distance computation, both of which also take into account every non-zero dimension value for both vectors.

### Storage Format: Third Format Option

A third storage format option is useful for binary vectors, where every dimension value is represented by a single bit (1 or 0). This storage format only stores the non-zero dimension positions. The non-zero dimension values array are skipped in this storage format because the non-zero dimension values are all 1s.

The data layout for this third storage format is similar to the data layout for the first storage format, except that there is no field for storing the dimension value array.

The Hamming distance computation is a relevant distance function for binary vectors. A high-level process for computing the Hamming distance between two binary vectors is as follows. First, the intersecting non-zero dimension positions between the two binary vectors are identified and the number of these intersecting positions is referred to as I_COUNT. The union of non-zero dimension positions between the two binary vectors are identified and the number of these positions is referred to as U_COUNT. The Hamming distance is computing by subtracting I_COUNT from U_COUNT. This operation may be performed efficiently with SIMD instructions.

### Storage Format: Fourth Format Option

A fourth storage format option relies on delta encoding the non-zero dimension positions array. Delta encoding is a compression technique where the differences between consecutive non-zero dimension positions are calculated as opposed to storing the positions themselves. Because the dimension positions are indicated in increasing order, delta encoding can provide substantial space savings. Delta encoding allows dimension positions to be represented using fewer bytes or even with bits.

For example, a dimension positions array has the following positions: [p1, p2, . . . pn]. If delta encoding is applied to these position values, then the dimension positions array would be updated to have the following values: [p1, (p2−p1), (p3−p2), . . . (pn−pn−1)]. If the vector is very sparse, then it is possible that the difference between two dimension positions could be very high, leading to less effective compression. For example, a difference between position 1 and position 30,678 is 30677, which would require two bytes to be represented.

In such cases, in an embodiment, delta encoding is performed on fixed-size blocks of every, for example, sixteen dimensions. This can localize large gaps to each fixed-size block which can improve compression. For example, each block of sixteen consecutive dimension position values in the dimension positions array is delta encoded. The first value in each block will be the actual position value. In such an embodiment, the storage format includes a field that indicates the size of each block, or the number of consecutive dimension position values that the block covers.

In order to determine the size of a block, the dimension positions array is automatically analyzed (e.g., a sparse vector format selector that executes within VDBMS 100) to determine which block size reduces the total size of a vector. The selected block size may be one of multiple pre-defined block sizes that the format selector considers when estimating a size of the vector. Selection of block size may be on a per-vector basis or on a per set of vectors basis, such as on a per-column basis. While selecting block size on a per-vector basis may be more accurate, if vectors are stored in a columnar format in a columnar unit (CU), then all the vectors in a set of vectors may be analyzed for every CU and a block size selected for that CU.

In a related embodiment, one or more blocks in a dimension positions array are delta encoded while one or more other blocks in the same dimension positions array are not delta encoded. For example, the non-zero dimension positions are analyzed to determine if there are too many large gaps based on some threshold. For example, if a goal is to represent the dimension positions as 1B, then the difference between no two dimensions should be greater than 255 positions. After the analysis, a hybrid encoding scheme may be selected where certain specific blocks are delta encoded that do not have large gaps, and other blocks are left unencoded. Thus, raw dimension positions are maintained. However, this approach may require introducing additional metadata per block to track how many bytes each dimension position is consuming. This means that fields need to be added to the vector's metadata to indicate which blocks are delta encoded and/or which blocks are not delta encoded.

Storage Format: Variability with Vector Indexes

In an embodiment, vectors that are stored in a vector column of a table are stored in one storage format but are stored in a different storage format in a vector index that is built on that vector column. For example, vectors in a vector column are stored with a dimension positions array and a dimension values array, whereas corresponding vectors are stored as key-value pairs in a vector index on that vector column. Examples of a vector index include an IVF index and an HNSW index. Such a difference in storage formats may be made because the vector index is based on a Euclidean distance function, which benefits from key-value pairs (or dimension position-dimension value pairs).

### Storage Format: Selection

In an embodiment, a storage format is selected from among multiple possible storage formats based on one or more selection criteria. Example selection criteria include the specific type of dimension format, a distance function chosen for a vector index on a vector column (if such a vector index exists), and the count and distribution of non-zero dimension values across one or more sparse vectors.

For example, if the dimension format of a vector (or of a column that stores the vector) is binary, then the third storage format is selected (i.e., store a single array of positions of non-zero dimension values). If not, then the distance function is considered. If the distance function chosen for a vector index on a vector column is dot distance, hamming, or cosine distance, then the first storage format is selected (i.e., one array for storing the positions of non-zero dimension values and another array for storing the corresponding non-zero dimension values). If the distance function is Euclidean, Euclidean squared, or Manhattan, then the second storage format is selected (i.e., a single array of key-value pairs).

Even after one of storage formats is selected, a determination may be made regarding whether to delta encode dimension position values. If a set of vectors have a large number (e.g., greater than 20%) of non-zero dimension values, then fixed-block delta encoding is selected and implemented. If a set of vectors have a small number (e.g., less than 1%) of non-zero dimension values that are spread wide apart, then the hybrid encoding option is selected and implemented.

### Distance Computations

In an embodiment, a database (e.g., SQL) function is defined that accepts two vectors as input and computes a distance between the two vectors. An example specification of a distance function is as follows:
VECTOR_DISTANCE(vec1, vec2, <optional distance function>)

In this example, there is an optional third parameter that specifies a distance function. In an embodiment where VDBMS 100 supports multiple distance functions, if no distance function is specified in a distance function call, then a default distance function is used, such as Euclidean distance or cosine distance.

In an embodiment, one or more distance functions accept a sparse vector and a dense vector as input in a single distance function call, as long as the embeddings (from which the vectors are based) are generated by the same embedding model. For example, a process that detects two vectors that are input to a distance function determines whether the two vectors originate from the same embedding model. This determination may be made based on metadata associated with each vector, such as an embedding model number or a version number.

In an embodiment, one or more distance functions accept sparse vectors in different storage formats. For example, one of the two input vectors is in the first storage format and another of the two input vectors is in the second storage format. A process that processes the calling of the distance function may convert one of the two vectors from one storage format to the other. For example, the process converts an array of key-value pairs into two arrays: a non-zero dimension positions array and a non-zero dimension value array. Alternatively, a process that executes the distance function takes into account the different storage formats without converting the storage format of one of the two input vectors to the storage format of the other of the two input vectors.

### Auto-Sparseness Detection

In an embodiment, a vector column stores both sparse vectors and dense vectors. This embodiment has utility along with the flexible specification embodiment to make vector specification even more flexible. In such a scenario, VDBMS 100 (or a storge engine thereof) determines the “sparseness” of a vector automatically during insertion of the vector. The sparseness of a vector may be measured in one or more ways, such as a number of zero dimension values or a percentage of non-zero dimension values. For example, a vector is analyzed to determine the percentage of non-zero values in the vector. If that percentage is below a particular pre-defined threshold, then VDBMS 100 selects a sparse storage format.

This embodiment allows a single vector column to store both sparse vectors and dense vectors and yet allows the storage and access engine to benefit from sparse vector optimizations described herein.

### Example Process

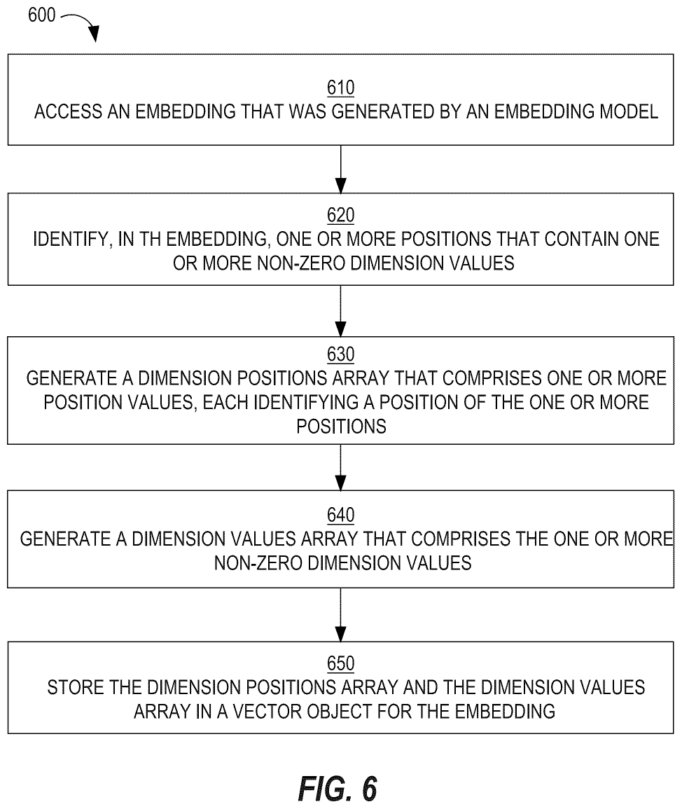

FIG. 6 is a flow diagram the depicts an example process 600 for generating a sparse vector representation, in an embodiment.

At block 610, an embedding that was generated by an embedding model is accessed. Block 610 may be preceded by a step of identifying a file that stores output from the embedding model. Then block 610 may involve identifying a next embedding in the file. For example, the first iteration of block 610 may involve identifying the first embedding in the file, the second iteration of block 610 may involve identifying the second embedding in the file, and so forth. Block 610 may also involve, for each embedding accessed, whether to generate a sparse vector based on the embedding or whether to generate a dense vector based on the embedding.

At block 620, one or more positions, in the embedding, that contain one or more non-zero dimension values are identified. Block 620 may involve scanning the embedding from the first dimension value in the embedding to the last dimension value in the embedding and, for each value, determining whether that dimension value is a non-zero value. If so, then the position of that dimension value is recorded, such as in a temporary data structure.

At block 630, a dimension positions array that comprises one or more position values, each identifying a position of the one or more positions, is generated. The dimension positions array records the positions, in the embedding, of the non-zero dimension values. The positions values are stored in increasing order. Block 630 may involve performing delta encoding on the position values in order to reduce the amount of data required to store the position values.

At block 640, a dimension values array that comprises the one or more non-zero dimension values is generated. The non-zero dimension values are ordered in the dimension values array in increasing order so that the first position value in the dimension positions array corresponds to the first non-zero dimension value in the embedding and in the dimension values array, the second position value in the dimension positions array corresponds to the second non-zero dimension value in the embedding and in the dimension values array, and so forth.

At block 650, the dimension positions array and the dimension values array are stored in a vector object for the embedding. The vector object may include other data, such as the number of dimension values in the embedding (e.g., dimension count), the number of non-zero dimensions, the storage format of the sparse vector, the dimension format, version number etc.

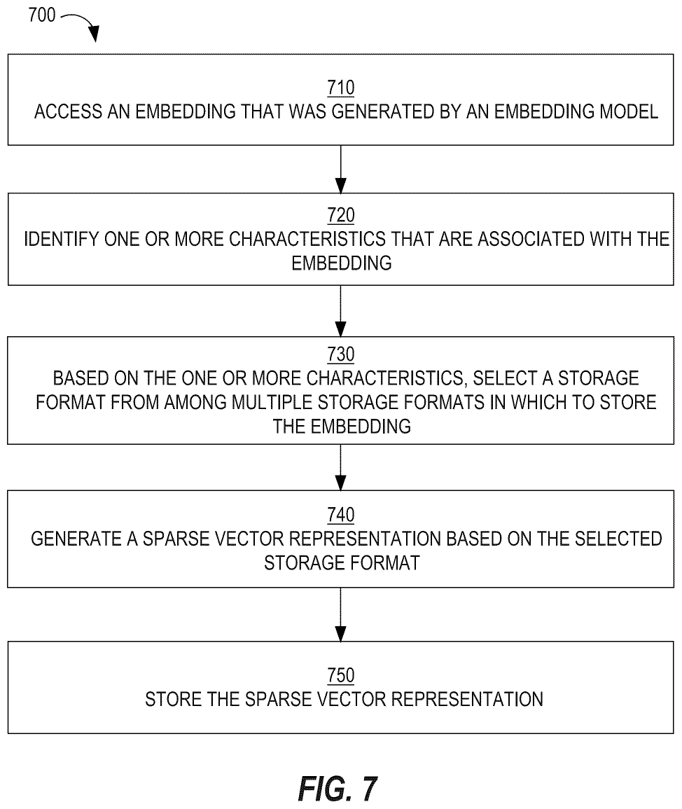

FIG. 7 is a flow diagram that depicts an example process 700 for determining a storage format for a sparse vector, in an embodiment.

At block 710, an embedding that was generated by an embedding model is accessed. Block 710 may involve retrieving the embedding from storage upon being notified that the embedding was generated or upon receiving an instruction to generate vectors for a set of embeddings at a specified storage location.

At block 720, one or more characteristics associated with the embedding are identified. Example characteristics include a percentage of the dimension values of the embedding that are non-zero dimension values, a distance function that is to be used with respect to the embedding and other embeddings, and a data type of the dimension values.

At block 730, a storage format is selected from among a plurality of storage formats in which to store the embedding. This selection is based on the one or more characteristics. For example, a first subset of the characteristics may be used to determine whether to generate a sparse vector representation or a dense vector representation, while a second subset of the characteristics may be used to determine in which of multiple storage formats to generate a sparse vector representation.

At block 740, a sparse vector representation is generated based on the embedding and the selected storage format. Block 740 may comprise blocks of process 600 for generating the sparse vector representation, including generating a dimension positions array and a dimension values array.

At block 750, the sparse vector representation is stored. Block 750 may include generating metadata and storing the metadata and the sparse vector representation in a vector object and, eventually, storing the vector object in a column of vectors, which may comprise other sparse vectors having the same storage format, dense vectors, and/or other sparse vectors having different storage formats.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

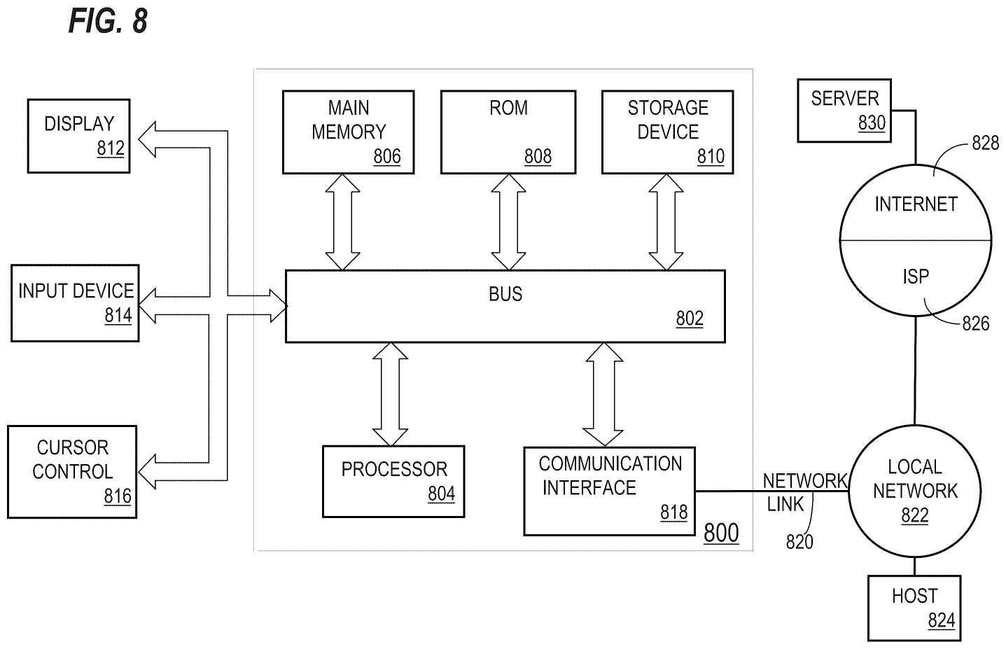

For example, FIG. 8 is a block diagram that illustrates a computer system 800 upon which an embodiment of the invention may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic, or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the worldwide packet data communication network now commonly referred to as the “Internet” 828. Local network 822 and Internet 828 both use electrical, electromagnetic, or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### Software Overview

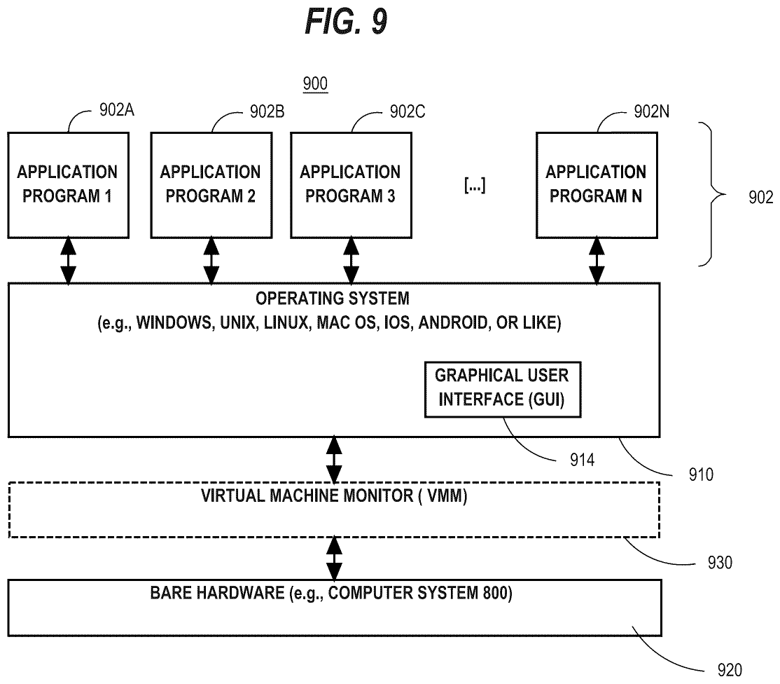

FIG. 9 is a block diagram of a basic software system 900 that may be employed for controlling the operation of computer system 800. Software system 900 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 900 is provided for directing the operation of computer system 800. Software system 900, which may be stored in system memory (RAM) 806 and on fixed storage (e.g., hard disk or flash memory) 810, includes a kernel or operating system (OS) 910.

The OS 910 manages low-level aspects of computer operation, including managing execution of processes, memory allocation, file input and output (I/O), and device I/O. One or more application programs, represented as 902A, 902B, 902C . . . 902N, may be “loaded” (e.g., transferred from fixed storage 810 into memory 806) for execution by the system 900. The applications or other software intended for use on computer system 800 may also be stored as a set of downloadable computer-executable instructions, for example, for downloading and installation from an Internet location (e.g., a Web server, an app store, or other online service).

Software system 900 includes a graphical user interface (GUI) 915, for receiving user commands and data in a graphical (e.g., “point-and-click” or “touch gesture”) fashion. These inputs, in turn, may be acted upon by the system 900 in accordance with instructions from operating system 910 and/or application(s) 902. The GUI 915 also serves to display the results of operation from the OS 910 and application(s) 902, whereupon the user may supply additional inputs or terminate the session (e.g., log off).

OS 910 can execute directly on the bare hardware 920 (e.g., processor(s) 804) of computer system 800. Alternatively, a hypervisor or virtual machine monitor (VMM) 930 may be interposed between the bare hardware 920 and the OS 910. In this configuration, VMM 930 acts as a software “cushion” or virtualization layer between the OS 910 and the bare hardware 920 of the computer system 800.

VMM 930 instantiates and runs one or more virtual machine instances (“guest machines”). Each guest machine comprises a “guest” operating system, such as OS 910, and one or more applications, such as application(s) 902, designed to execute on the guest operating system. The VMM 930 presents the guest operating systems with a virtual operating platform and manages the execution of the guest operating systems.

In some instances, the VMM 930 may allow a guest operating system to run as if it is running on the bare hardware 920 of computer system 800 directly. In these instances, the same version of the guest operating system configured to execute on the bare hardware 920 directly may also execute on VMM 930 without modification or reconfiguration. In other words, VMM 930 may provide full hardware and CPU virtualization to a guest operating system in some instances.

In other instances, a guest operating system may be specially designed or configured to execute on VMM 930 for efficiency. In these instances, the guest operating system is “aware” that it executes on a virtual machine monitor. In other words, VMM 930 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
accessing an embedding that was generated by an embedding model;
based on one or more characteristics associated with the embedding, selecting a particular storage format from among a plurality of storage formats in which to store the embedding;
wherein the one or more characteristics include (a) a distance function that is to be used with the sparse vector representation or (b) a dimension format of dimension values in the embedding;
generating a sparse vector representation based on the embedding and the particular storage format;
storing, in persistent storage, the sparse vector representation;
wherein the method is performed by one or more computing devices.

2. The method of claim 1, wherein the one or more characteristics include the distance function that is to be used with the sparse vector representation.

3. The method of claim 2, wherein the distance function is one of dot distance, cosine distance, hamming, Euclidean, Euclidean squared, or Manhattan.

4. The method of claim 1, wherein:
the one or more characteristics include the dimension format of dimension values in the embedding;
the method further comprising:
making a determination that the dimension format is a binary format;
selecting the particular storage format based on the determination;
storing the sparse vector representation includes storing, within the sparse vector representation, a dimension positions array but not a dimension values array.

5. The method of claim 1, further comprising:
determining whether to store the embedding as a sparse vector or a dense vector;
wherein generating the sparse vector representation is performed in response to determining to store the embedding as a sparse vector.

6. The method of claim 5, wherein determining whether to store the embedding as a sparse vector comprises:
determining a percentage of values in the embedding that are non-zero values;
determining whether the percentage of values is less than a particular threshold percentage.

7. The method of claim 1, further comprising:
determining a distribution of a plurality of positions, within the embedding, that have non-zero dimension values;
determining whether to perform delta encoding on the position values of the plurality of positions.

8. The method of claim 1, further comprising:
receiving a table specification that specifies a column having a VECTOR data type;
wherein the table specification does not specify either a SPARSE type or a DENSE type.

9. The method of claim 8, further comprising:
storing, in the column, the sparse vector representation and one or more dense vectors representations.

10. A method comprising:
accessing an embedding that was generated by an embedding model;
identifying a particular storage format from among a plurality of storage formats in which to store the embedding;
generating a first sparse vector representation based on the embedding and the particular storage format;
storing, in persistent storage, the first sparse vector representation in a vector column that also stores a second sparse vector representation that is stored in a different storage format than the particular storage format of the first sparse vector representation.

11. The method of claim 1, further comprising:
receiving an instruction to convert the sparse vector representation to a dense vector representation;
converting the sparse vector representation to the dense vector representation, wherein converting comprises:
creating a dense array that contains a zero in each entry of the dense array;
for each position indicated in a dimension positions array of the sparse vector representation:
identifying a value, in a dimension values array of the sparse vector representation, that corresponds to said position;
inserting the value into an entry, of the dense array, at said position.

12. The method of claim 1, further comprising:
generating a vector index that includes a modified copy of the sparse vector representation;
wherein the modified copy of the sparse vector representation is in a second storage format that is different than the particular storage format.

13. The method of claim 1, further comprising:
receiving an instruction to compute a distance between the embedding of the sparse vector representation and an embedding of a dense vector representation;
in response to receiving an instruction, determining whether the embeddings of the sparse vector representation and the dense vector representation were generated by the same embedding model;
in response to determining that the embeddings of the sparse vector representation and the dense vector representation were generated by the same embedding model, computing the distance between the embeddings of the sparse vector representation and the dense vector representation.

14. The method of claim 1, wherein the sparse vector representation is a first sparse vector representation, the method further comprising:
receiving an instruction to compute a distance between the embedding of the first sparse vector representation and an embedding of a second sparse vector representation that is in a second storage format that is different than the particular storage format of the first sparse vector representation;
in response to receiving the instruction, computing the distance between the embedding of the first sparse vector representation and the embedding of the second sparse vector representation.

15. The method of claim 1, wherein the sparse vector representation comprises a dimension positions array and a dimension values array, the method further comprising:
determining a number of values in the embedding;
storing the number of values in a position, of the sparse vector representation, that is logically before the dimension positions array and logically before the dimension values array.

16. The method of claim 1, further comprising:
receiving a request to return the sparse vector representation in a particular data type that is one of variable character, CLOB, or JSON.

17. The method of claim 16, wherein the request indicates a sparse format or a dense format.

18. One or more non-transitory storage media storing instructions which, when executed by one or more computing devices, cause:
accessing an embedding that was generated by an embedding model;
based on one or more characteristics associated with the embedding, selecting a particular storage format from among a plurality of storage formats in which to store the embedding;
determining whether to store the embedding as a sparse vector or a dense vector;
in response to determining to store the embedding as a sparse vector, generating a sparse vector representation based on the embedding and the particular storage format;
storing the sparse vector representation in persistent storage.

19. The one or more storage media of claim 18, wherein the one or more characteristics include a distance function that is to be used with the sparse vector representation.

20. (canceled)

21. The one or more storage media of claim 18, wherein the sparse vector representation is a first sparse vector representation, wherein the instructions, when executed by the one or more computing devices, further cause:
storing the first sparse vector representation in a vector column that also stores a second sparse vector representation that is stored in a different storage format than the particular storage format of the first sparse vector representation.
